(19) United States
(12) Patent Application Publication
(10) Pub. No.: US 2002/0189601 A1
(43) Pub. Date: Dec. 19, 2002

(54) Air enriched gas induction system (AEGIS)

(75) Inventors: Stephen Morrison, Lakewood, WA (US); Conly Lee, Tacoma, WA (US)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: Concepts Unlimited, Inc.

(21) Appl. No.: 10/143,773

(22) Filed: May 14, 2002

Related U.S. Application Data
(60) Provisional application No. 60/290,346, filed on May 14, 2001.

(51) Int. Cl. F02B 23/00

(52) U.S. Cl. 123/585

(57) ABSTRACT

A system for electronically controlled generation of oxygen and hydrogen gas from an electrolyte. Ambient air is drawn into the system through the air filter and into the inlet hose. The flow of air is caused by the venturi effect of engine intake air passing over the base of the 90 degree induction fitting. The flow of air across the air flow sensor causes the controller to direct power to the chamber power lugs. At the same time, the controller monitors the level of electrolyte in the chamber case. Should the level of electrolyte drop below the upper edge of the process plates, the controller will then cause power to be directed to the reservoir pump to restore electrolyte fluid to a predefined level. In addition to monitoring electrolytic solution level, the controller monitors voltage and amperage across the two chamber power lugs, and the temperature of the electrolytic solution in the process chamber case. This information is stored in the controller and displayed when requested. The controller also displays error codes when the system fails or its performance is compromised.

### BACKGROUND OF THE INVENTION

1. Field of the Invention

The present invention relates to the field of internal combustion engines, in particular, specialized air intake systems.

2. Background Art

The technology of producing hydrogen and oxygen gases from an electrolyte is a relatively known one. Furthermore there have been several inventions where these hydrogen and oxygen gases have been used to supplement the air fuel mixture used in an internal combustion engine. Generally, the hydrogen and oxygen gases are produced in an external electrolysis unit and then introduced to the engine system through the air intake where they are then able to mix with the fuel. The result of this addition to the internal combustion engine is both better mileage and emission.

Although there are known systems using the process of electrolysis to supplement the fuel systems of a internal combustion engine, such systems have not been successful in their operation due to lack of general control of the system. No previous system has integrated the ability to maintain the entire system at the proper levels for the process to continue to run effectively over time. In order to maintain the correct levels of electrolyte, system amperage, temperature, and necessary voltage, the constantly changing system must be adjusted to maintain equilibrium. Such an equilibrium is necessary to the successful functioning of the system.

There is a need for a system which can monitor its conditions through a network of feedback sensors and to use such information to maintain necessary conditions in order to achieve maximum performance. Control over the system is essential to its ability to properly function.

### BRIEF SUMMARY OF THE INVENTION

An air enriched gas induction system of the present invention includes a chamber including a plurality of process plates, and an air filter connected to the chamber which provides air to the chamber. The system also includes a reservoir containing a conductive fluid, and a pump connected to the reservoir and the chamber for providing conductive fluid to the chamber. The system includes a controller which monitors a characteristic of the system. The characteristic may be the level of the conductive fluid in the chamber, voltage across the chamber power lugs, amperage across the chamber power lugs, the temperature of the conductive fluid, the temperature of the chamber, or any combination thereof.

Additionally, the controller may display an indication when the characteristic is below or above a predefined range. Further, the controller can control the power to be directed to the pump to restore said conductive fluid to a predefined level when the level of conductive fluid drops below a predefined level.

The system may further include an airflow sensor for monitoring the flow of air from the air filter to the chamber, and the output may be displayed on the controller. Additionally, a liquid anti-bio-fouling agent may be added to the system.

In practice, ambient air is drawn into the system through the air filter and into the inlet hose. The flow of air is caused by the venturi effect of engine intake air passing over the base of the 90 degree induction fitting. The flow of air across the air flow sensor causes the controller to direct power to the chamber power lugs. At the same time the controller monitors the level of electrolyte in the chamber case. Should the level of electrolyte drop below the upper edge of the process plates, the controller will then cause power to be directed to the reservoir pump to restore electrolyte fluid to a predefined level. In addition to monitoring electrolytic solution level, the controller also monitors voltage and amperage across the two chamber power lugs as well as the temperature of the electrolytic solution in the process chamber case. This information is stored in the controller and displayed when requested. The controller may display error codes when the system fails or its performance is compromised.

### BRIEF DESCRIPTION OF THE FIGURES

FIG. 1 is a schematic diagram of the system of the invention.

FIG. 2 is a perspective view of the system of the invention including the control system.

FIG. 3 is a transparent perspective view of the generating unit showing anode and cathode plate arrangement.

### DETAILED DESCRIPTION OF THE INVENTION

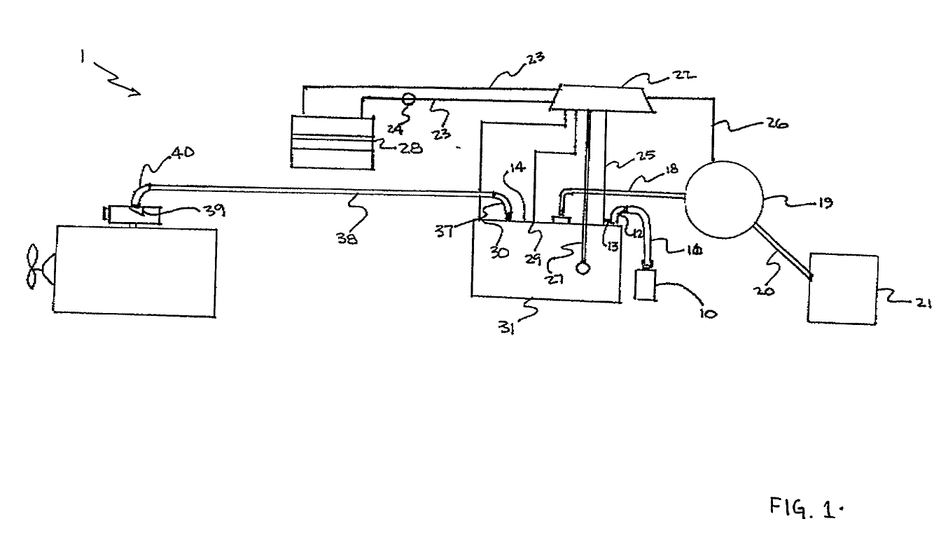

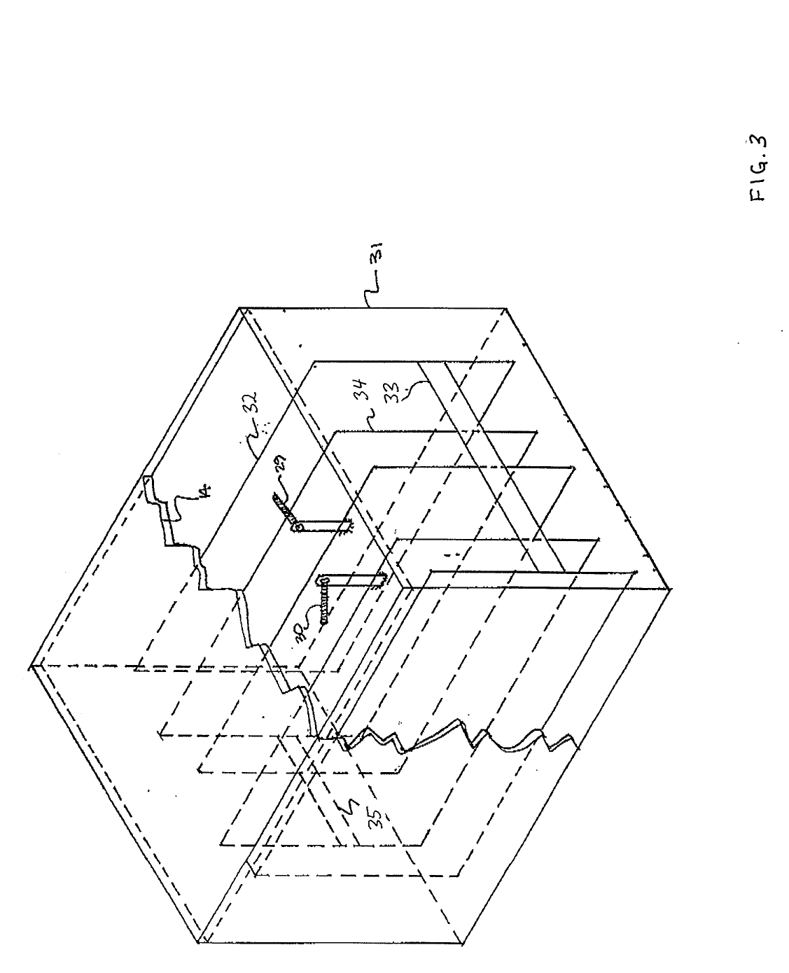

Referring to the drawings, FIG. 1 shows a schematic diagram of the gas induction system 1. The gas induction system includes a chamber 31. Chamber 31 is a tank of conductive fluid with conductive plates, as shown in greater detail in FIG. 3.

In the embodiment shown in FIG. 3, chamber 31 houses anode plates 32 and cathode plates 34, which transform the conductive fluid contained therein, through the process of electrolysis, into hydrogen and oxygen gases. The spacing of plates 32 and 34 is such that opposite polarity plates are most effective in product operation.

In a preferred embodiment, the conductive fluid may be a pure water base with a conductive additive. This additive preferably includes acetic acid U.S.P.-F.C.C. Food Grade at 0.25 to 0.99% fluid ration, alcohol, and a liquid anti-bio-fouling agent. The fluid may preferably contain the Iron bacteria, Gallionella ferruginea, which can cause a degradation of performance and life due to the accumulation and growth of the bacteria. Contaminated fluid causes increased conduction currents, which may result in system failure or shutdown. The addition of liquid anti-bio-fouling agent specific to controlling Iron bacteria, Gallionella ferruginea, protects chamber 31.

Chamber 31 is supplied with electrolyte via reservoir 21. Reservoir 21 is connected by reservoir hose 20 to reservoir pump 19 which is connected by pump hose 18 to chamber 31. Reservoir pump 19 is connected to controller 22 by a reservoir pump power wiring harness 26. Battery 28 supplies power to controller 22 by a power wiring harness 23. An inline fuse 24 is preferably located on power wiring harness 23. Chamber 31 is connected to controller 22 by a chamber sensor probe 27.

Positive chamber power lug 29 and negative chamber power lug 30 provide power to chamber 31 from controller 22. The resulting reaction produces a mixture above and in the fluid. Air passes through an air filter 10 and into inlet hose 11 which is attached to chamber 31 by 90 degree inlet fitting 12. Air flow sensor 13 is located at the connection point between 90 degree inlet fitting 12 and chamber 31. Air flow sensor 13 is connected to controller 22 by an airflow switch 25. The externally filtered air is mixed with the reaction product above the fluid, and is then piped to the intake of a combustion device. Because the external air entering the region above the fluid may not mix thoroughly with the gas mixture, specifically directed air flow chambers may be provided to mix the air and gas throughly, which results in improved mileage and reduced emissions. A non-corrosive flashback preventer made of metallic heat absorbing combustion suppressor may be provided to prevent combustion of the gas mixture in the chamber 31.

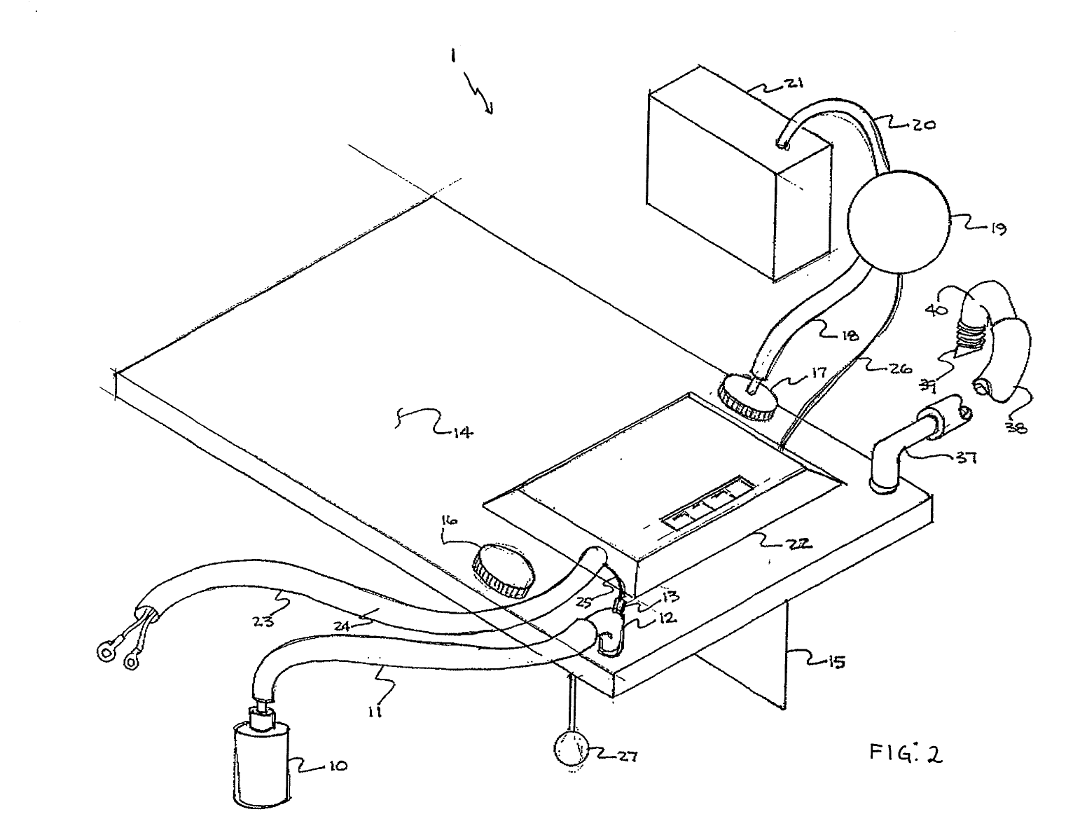

The air enriched mixture exits chamber 31 into 90 degree air enriched gas outlet fitting 37 which is connected to a flash arrester 40 by an outlet hose with clamps 38. Flash arrester 40 is connected to a 90 degree induction fitting by a venturi device 39, which produces the required vacuum. FIG. 2 shows a perspective view of the gas induction system of the present invention.

Typical thermal control may cause thermal overshoot, resulting in inconsistent product generation. This condition is aggravated by thermal time constants in the system. A processor control of pulse width modulation as a function of temperature, amperage, voltage, and time can regulate the rate of change of temperature used to project tank temperature. Energy dumps in many electrical systems produce voltages above normal operating levels. Protection typically is provided by transient absorbers. Fluid is used as an energy sump to consume energy transients.

Controller 21 can control the power to be directed to the pump to restore said conductive fluid to a predefined level when the level of conductive fluid drops below a predefined level.

Controller 22 can monitor one or more characteristics of the system. Such characteristics include the level of the conductive fluid in the chamber, voltage across the chamber power lugs, amperage across the chamber power lugs, the temperature of the conductive fluid, temperature of the chamber, or any combination thereof. In a preferred embodiment, controller 22 monitors the level of the conductive fluid in the chamber, voltage across the chamber power lugs, amperage across the chamber power lugs, the temperature of the conductive fluid, and the temperature of the chamber. Additionally, the controller preferably displays an indication when one of the characteristics is below or above a predefined range. In a preferred embodiment, the data from controller 21 is retrieved via a display and single switch and or external monitoring device.

Preferably, when a characteristic's maximum limit is reached, the system will change operation from normal to protective. Preferably, when a characteristic's level below protective, but above normal is reached, the system will produce a warning indicating that the system is in the warning region. In alternate embodiments, the system may provide a series of warnings when a characteristic reaches a series of levels.

The system may monitor and control delays in system operation times, system fluid temperature, system operation times, water pump sample periods, and distiller run time.

In an alternate embodiment, the system may include a controller, two tank chambers, a first internal tank and a second external tank, and a distiller.

In a preferred embodiment, controller 22 is comprised of a printed circuit board (PCB) and a display. The PCB preferably has a width of approximately 3.50 inches, a height of approximately 0.75 inches from its bottom to the top of its highest part and a length of approximately 5.90 inches. The PCB may be preferably constructed from 4 oz min. 94 VO FR4 0.62 G10 or better and its weight is nominally 6 oz. The parts attached to the printed circuit board may be mixed media, such as Surface Mount Technology (SMT), and through hole. SMT parts are preferably only placed on the top side of the PCB. The parts may be bolted or soldered, by wire or weather pack connector, to the PCB. Mounting may be through bolts or restraints. The display is a combination of three, seven segment digits with decimal points, a colon, and a special LED. The digit height is preferably approximately 0.28 inches and the display color is preferably red. Ventilation of the controller 22 is preferably through free air at a minimum rate of 1 cubic foot per minute.

In a preferred embodiment, the first tank is an internal insulated tank of fluid with conductive plates spaced in pattern in the tank. The pattern is such that fluid level and opposite polarity plates are most effective in product operation. The fluid may be a pure water base with a conductive additive, preferably acetic acid. Switched electrical power is then applied to the conductive plates. The resulting reaction produces a mixture above the fluid. The resulting gas is piped to the intake of a combustion device. Temperature, pulse width, fluid level and time are used to control the process.

The first tank's liquid level, temperature, and current are controlled by input to one channel of an Analog/Digital (A/D) converter. A filter capacitor may be provided to reduce electrical noise. An 8 bit successive approximation mixed-input, analog-to-digital converter may be added to sample the sensor every period.

Plates in the fluid are connected to a fused battery and a Field Effect Transistor (FET) switch. When the switch is open the entire fluid is a positive potential. A small conductive probe may be placed at the desired fluid level. A current limiting resistor is in series with the A/D convertor. A pull down resistor provides a baseline in the event that the fluid is low. The A/D channel reports a lower count if the fluid is not in contact with the probe.

A protective vial may be sealed to the tank. The major portion of the vial is within the fluid. The sensor is installed deep into the vial and sealed. As the fluid temperature changes, the sensor output voltage changes in direct proportion to the fluid temperature. This voltage is filtered by the resistor and capacitor and presented to one channel of the A/D converter.

A sensor resistor may be in the FET source path connected to the negative side of a battery. Current that flows in this resistor produces a voltage that is proportional to the current in the tank. To reduce heating and losses, the resistor value is quite small in value, approximately 0.005 ohms. A gain stage amplifies this small voltage to a larger voltage. Gain stage input protection is provided by a series resistor and clamp diode. Input filtering is provided by the series resistor and averaging capacitor. Gain is set at 40 times by two resistors in the negative feedback circuit. A second level of averaging is provided by an averaging capacitor across the feedback resistor. At 25.6 amps average, the stage produces a 5.12 volt output. A filter capacitor and resistor is provided to reduce electrical noise. This signal is presented to the A/D.

The first tank's over current is controlled by a shunt followed by a comparator stage that provides signal logic. If current is above limit, output conduction is terminated until reset. Termination is reported to the processor input/output (I/O). Request for conduction, unless having been previously made, results in an output stage in conduction. The level of conduction results in a current through the 0.005 ohm shunt, which produces a voltage proportional to the current. This voltage is limited and filtered by a resistor and filter capacitor. Additional protection is provided by a clamp diode. Two resistors, for a voltage divider, of which voltage corresponds to the allowed voltage, are disposed across the shunt. Current limits may be preferably set at 24.8 amps. Noise filtering may be provided on the divider.

The first tank's internal pump is provided to replenish the consumed pure water in the tank, as advised by the tank one level sensor from internal water storage reservoir. Power for the pump is passed through the tank, thus, reducing power to the pump motor and preventing pumping in the event of a failure that results in an empty tank.

A second tank may be provided which is preferably an externally insulated tank of fluid and operates in substantially the same way as the first tank. Further, an external distiller may be provided to replenish the consumed pure water in the storage tank or tanks, which operates in substantially the same way as the first and second tanks. The external distiller is capable of sensing consumable water level and when low, the system reports the need for more water. The distiller is also capable of sensing normal operation and recognizing and displaying a signal when the operation is outside normal range.

The system power may be provided by a fused battery. The battery is preferably divided into an inner tank, external tank, and system pre-regulator. This linear stage manages the difference between nominal 12 volts for internal use and for battery use. Transient levels of 112 volts can be managed. PCB design is supportive of components to 250 volts. Secondary regulation to 5.12 volts provides processor, A/D reference, and switched 5 volt supplies. Hardware provides a keep-alive or sleep mode, which allows for section powering down for periods of reduced current need. The secondary regulator is controlled by a processor power keep-on mode or an external key power up. Voltages above the on key line will power the unit on. During power up and abnormal conditions, a current sensing resistor develops voltage to turn on a shunt transistor, thereby limiting FET current. A base drive limiting resistor is preferably provided to protect the shunt transistor's base. Output storage and reduced impedance are preferably provided by a large capacitor. With a +12 supply, the FET output stage driver draws from this supply. High pulse current occurs during FET switching.

### EXAMPLE 1

In a preferred embodiment, monitor 21 of the system may display the following codes:

i. #0 WATER_HOT: SYSTEM TEST FOR WATER TEMP ERROR OR NO SENSOR

ii. #1 WATER_REG_TEMP: SYSTEM REGULATOR/OPERATING TEMPERATURE

iii. #2 WATER_LEVEL: SYSTEM TEST FOR WATER LEVEL

iv. #3 BATTERY_LOW: SYSTEM LOW BATTERY VOLTAGE

v. #4 BATTERY_UP: SYSTEM UPPER BATTERY VOLTAGE

vi. #5 AMPS_MAX SYSTEM MAX AMPS AVERAGE

vii. #6 PUMP_RUN: PUMP ON TIMER

viii. #7 PUMP_TIMER: PUMP TIMER

ix. #8 LED_TIMER: LED TEST TIME SECONDS

x. #9 LED_STATUS: CURRENT LED STATUS

xi. #10 T_ENG: ENGINER WARM UP TIME SECONDS

xii. #11 HRS_W_BAD: HRS WITH BAD WATER

xiii. #12 HRS_W_LOW: HRS WITH LOW WATER

xiv. #13 HRS_W_HOT: HRS WITH HOT WATER

xv. #14 HRS_B_BAD: HRS WITH BAD BATTERY

xvi. #15 HRS_OK_L: HRS OK

xvii. #16 HRS_OK_H

xviii. #17 DAY: DAY

xix. #18 MONTH: MONTH

xx. #19 YEAR: YEAR

xxi. #20 SOFT_REV: SOFTWARE REVERSION

xxii. #21 HARD_REV: HARDWARE REVERSION

xxiii. #22 PARITY: RAM CHECK WORD

xxiv. #23 PUMP_T_LEFT: TIME LEFT ON PUMP CYCLE

xxv. #24 nu

xxvi. #35 expansion area

### EXAMPLE 2

The following is a list of the functions of the system and corresponding display codes:

1. Normal display with power system power active

i. System

i. Model number

ii. Volts

(1) Display “1U” for 3 seconds

(2) Display “X.XX” Volts for 3 seconds

iii. System Temperature

(1) Display “F” for 3 seconds

(2) Display “XXX” deg “F” for 3 seconds

b. Tank 1

I. Current

(1) Display “1A” for 3 seconds

(2) Display “X.XX” amps for 3 seconds

ii. Temperature

(1) Display “1SF” for 3 seconds

(2) Display “XXX” deg “F” for 3 seconds

iii. Water Status

(1) Display “1uu” for 3 seconds

(2) Display “LO” for 3 seconds if bad

(3) Display “FL” for 3 seconds if ok

c. Tank 2 (if present)

I. Current

(1) Display “2A” for 3 seconds

(2) Display “X.XX” amps for 3 seconds

ii. Temperature

(1) Display “2SF” for 3 seconds

(2) Display “XXX” deg “F” for 3 seconds

iii. Water Status

(1) Display “2uu” for 3 seconds

(2) Display “LO” for 3 seconds if bad

(3) Display “FL” for 3 seconds if ok

2. Addition of long display

a. Hours of operation, electrical power

I. Display “OHr” for 3 seconds

ii. Display “XX.X” for 3 seconds

iii. Display “XXX” for 3 seconds

b. Hours of operation, over temp

I. Display “UcH” for 3 seconds

ii. Display “XX.X” for 3 seconds

iii. Display “XXX” for 3 seconds

c. Hours of operation, over current

I. Display “OCH” for 3 seconds

ii. Display “XX.X” for 3 seconds

iii. Display “XXX” for 3 seconds

d. Hours of operation, low water

I. Display “OLH” for 3 seconds

ii Display “XX.X” for 3 seconds

iii. Display “XXX” for 3 seconds

e. Hours of operation, pump

I. Display “PHr” for 3 seconds

ii. Display “XX.X” for 3 seconds

iii. Display “XXX” for 3 seconds

f. Hours of operation, low battery

I. Display “OLB” for 3 seconds

ii. Display “XX.X” for 3 seconds

iii. Display “XXX” for 3 seconds

g. Hours of operation, high battery

I. Display “OHB” for 3 seconds

ii. Display “XX.X” for 3 seconds

iii. Display “XXX” for 3 seconds

h. Model Number

I. Display “CU” for 3 seconds

ii. Display “XX.X” for 3 seconds

i. Reversion of software

i. Display “5ru” for 3 seconds

ii. Display “XXX” for 3 seconds

j. Reversion of hardware

i. Display “Hrv” for 3 seconds

ii. Display “XXX” for 3 seconds

k. Day, month, year of manufacture

I. Display “dnY” for 3 seconds

ii. Display “XX” for 3 seconds day

iii. Display “XX” for 3 seconds month

l. Error codes level 1 tank #1

I. Current in tank one to high

(1) Display “E11”

ii. Temperature in tank one to high

(1) Display “E12”

iii. Water level in tank one to low

(1) Display “E13”

iv. Pump current high

(1) Display “E14”

m. Error codes level 2 tank #2

I. Tank two not active high

(1) Display “E21”

ii. Current in tank one to high

(1) Display “E22”

iii. Temperature in tank one to high

(1) Display “E23”

iv. Water level in tank one to low

(1) Display “E24”

V. Pump current high

(1) Display “E25”

n. Error codes level 3 distiller

I Distiller not active

(1) Display “E31”

ii. Current distiller to high

(1) Display “E32”

o. Error codes level 4 general system problem

I. Voltage to low

(1) Display “E41”

ii. Voltage to high

(1) Display “E42”

iii. System temperature to high

(1) Display “E43”

3. Programming

a. Display “PRO” for 3 seconds

b. Start up delay

I. Display “SOL”

ii. Display “XXX”

(1) Increase or decrease by one count=one second

C. Selection of external system tank

I. Display “E2”

ii. Display “Off” external off

iii. Display “O” external on

d. Selection of system voltage

I. Display “5vo”

(1) cycle through system voltages

(a) 12 u system 12 volt system

(b) 24 u system 24 volt system

(c) 36 u system 36 volt system

e. Selection of low battery limit

I. Display “LOU”

(1) Display “XX.X”

(a) Increase or decrease within limits by one count

f. Selection fo battery system on voltage or key system

I. Display “OUO”

(1) Display “XX.X”

(a) Increase or decrease within limits by one count

4. Advanced programming

a. Display “APR” for 3 seconds

b. Tank control temperature

I. Display “Cc”

ii. Display “xxx”

c. Reset hours of operation ik, to hot, over current

I. Display “rSC”

ii Display “Do”

d. Selection of soft current limit for tank one

I. Display “CL1”

ii. Display “xx”

e. Selection of soft current limit for tank two

I. Display “CL2”

ii. Display “xx”

f. Selection of model number

I. Diaplay “CU”

ii. Display “xxx”

g. Pump max run time

I. Display “PCL”

ii. Display “xx”

(1) Increase or decrease within limits by one count

h. Program day of month

I. Display “dA”

ii. Display “xx”

I. Program month of year

I. Display “nn”

ii. Display “xx”

j. Program year

I. Display “Y”

ii. Display “xx”

What is claimed is:

1. An air enriched gas induction system, comprising:
a chamber including a plurality of process plates;
an air filter connected to said chamber which provides air to said chamber;
a reservoir containing a conductive fluid;
a pump connected to said reservoir and said chamber for providing conductive fluid to said chamber;
a plurality of chamber power lugs; and
a controller, wherein said controller monitors a characteristic of the system.

2. The system of claim 1, wherein said controller causes power to be directed to said pump to restore said conductive fluid to a first predefined level when the level of said conductive fluid drops below a second predefined level.

3. The system of claim 2, wherein said second predefined level is an upper edge of said process plates.

4. The system of claim 1, wherein said characteristic is the level of said conductive fluid in the chamber.

5. The system of claim 1, wherein said characteristic is voltage across said plurality of chamber power lugs.

6. The system of claim 6, wherein said controller displays an indication when said voltage across said plurality of chamber power lugs is below or above a predefined voltage range.

7. The system of claim 1, wherein said characteristic is amperage across said plurality of chamber power lugs.

8. The system of claim 7, wherein said controller displays an indication when said amperage across said plurality of chamber power lugs is below or above a predefined amperage range.

9. The system of claim 1, wherein said characteristic is the temperature of said conductive fluid.

10. The system of claim 9, wherein said controller displays an indication when said conductive fluid temperature is below or above a predefined conductive fluid temperature range.

11. The system of claim 1, wherein said characteristic is the temperature of said chamber.

12. The system of claim 11, wherein said controller displays an indication when said chamber temperature is below or above a chamber temperature range.

13. The system of claim 1, further comprising an airflow sensor for monitoring the flow of air from said air filter to said chamber.

14. The system of claim 13, wherein said controller displays the output from said airflow sensor.

15. The system of claim 1, wherein said conductive fluid is electrolyte solution.

16. The system of claim 1, further comprising a metallic heat absorbing combustion suppressor.

17. The system of claim 1, further comprising a liquid anti-bio-fouling agent.
